SEQUENCE LISTING (1 sequence)

SEQ ID NO: 1 - protein, 6 aa, Artificial Sequence
  recognition sequence
CCPGCC

(19) United States
(12) Patent Application Publication
(10) Pub. No.: US 2007/0172871 A1
(43) Pub. Date: Jul. 26, 2007

(54) Methods for profiling transcriptosomes

(76) Inventors: Larry J. Dishaw, Bradenton, FL (US); Gary W. Litman, Gulfport, FL (US); Robert N. Haire, Clearwater, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/655,668

(22) Filed: Jan. 19, 2007

Related U.S. Application Data
(60) Provisional application No. 60/760,489, filed on Jan. 20, 2006.

(51) Int. Cl. C40B 30/06; C40B 40/08

(52) U.S. Cl. 435/6

(57) ABSTRACT

The present invention concerns a method for profiling variations in gene transcription (e.g., variable RNA processing) from complex and/or unknown genomic regions. Rather than screening EST or cDNA libraries for transcripts of interest, the method of the invention involves the reverse, i.e., using the genetic locus responsible for the gene product as a tool to capture representatives from this (specific) region.

### CROSS-REFERENCE TO RELATED APPLICATION

The present application claims benefit of U.S. Provisional Application Ser. No. 60/760,489, filed Jan. 20, 2006, which is hereby incorporated by reference herein in its entirety, including any figures, tables, nucleic acid sequences, amino acid sequences, and drawings.

### GOVERNMENT SUPPORT

The subject matter of this application has been supported by a research grant from the National Institutes of Health under grant number AI23338. Accordingly, the government may have certain rights in this invention.

### BACKGROUND OF THE INVENTION

Understanding the transcriptosome, which is defined as the protein coding information contained within the genome, is far more complex an undertaking than originally considered. Even for the cases of the near fully-resolved/assembled human and mouse genomes, for which extensive databases of expressed sequence tags (ESTs) are available, it is not possible to define the full range of protein products. This is because information provided by the available EST databases is dependent on many factors associated with collection and processing of the genetic material. In addition, many genes are tightly regulated, including secondary processing of the MRNA, which will lead to a vast under-representation of transcripts, which could be of major interest (e.g., clinical relevance).

The complexity of the transcriptosome is of critical concern in biology and medicine, and presents an even greater problem in terms of understanding the functional significance of genomes in other species since the various protein (exon) search algorithms are based largely on previously described and integrated nucleic acid/protein data from human/mouse, and very few other representative species (e.g., fruit fly and round worm). Furthermore, it is accurate to state that the various computational-based prediction resources presently used to translate genomes are biased toward those genes that are relatively abundantly expressed, as these sequences tend to dominate conventional EST databases. To expand EST databases further requires considerable cost and is associated with diminishing returns; certain transcription products will be temporally dependent (such as those transcription products found in various developmental stages), making their detection difficult, inconsistent, and time consuming. Reverse transcription-polymerase chain reaction (RT-PCR) is the most sensitive technique for MRNA detection and quantitation currently available. Compared to the two other commonly used techniques for quantifying mRNA levels, Northern blot analysis and RNase protection assay, RT-PCR can be used to quantify mRNA levels from much smaller samples. However, the efficiency of characterizing transcriptional products using RT-PCR is encumbered by the requirement to predict structures (and design appropriate primers) where unforeseen variation in the transcripts may cause PCR to fail.

It would be advantageous to have available an efficient method for profiling variations in gene transcription from complex or unknown genomic regions.

### BRIEF SUMMARY OF THE INVENTION

The present inventors have developed methods for preparing genetic material for analysis and for profiling (identifying) variations in gene transcription (e.g., variable RNA processing) from complex and/or unknown genomic regions. Rather than screening EST or cDNA libraries for transcripts of interest, the method of the invention involves the reverse, i.e., using the genetic locus responsible for the gene product as a tool to capture representatives from this (specific) region. This is accomplished by first screening libraries constructed from genomic regions of DNA (in individual clones of up to 150,000 base pairs (bp) or larger), known as artificial chromosomes, such as bacterial artificial chromosomes (BAC) or P1 artificial chromosomes (PAC), which contain genetic regions of interest. BAC sequencing and sequence assembly has played an important role, not only in resolving the human genome but also in defining specific genetic regions that can be used for various investigational purposes.

In accordance with the method of the invention, the libraries (e.g., BAC or PAC libraries) are screened using gene-specific probes. A positively hybridizing clone will indicate that this gene, a part of this gene, or a closely related member of a gene family, is represented in this segment of DNA. In order to better understand the complete transcriptional output of this genetic region, the clone can then be transfected into a eukaryotic host cell, such as that of a eukaryotic tumor cell line. The resulting RNA can then be analyzed for the artificial chromosome-specific (e.g., BAC-specific or PAC-specific) transcripts.

The present inventors have developed this method using BAC and PAC clones that have been previously sequenced and assembled by different genome sequencing centers as well as through internal efforts. While a specific set of genes is known to reside in these genomic regions, little is known regarding their transcriptional variation (e.g., variable RNA processing). The present inventors have been using several in-house, well-characterized PAC and BAC clones and have been able to identify, using gene-specific primers, a variety of cDNAs, which include both the observed and expected (predicted) versions as well as novel splice variants. It is likely that complete analysis of transcriptional repertoires from specific artificial chromosome clones of interest will: 1) facilitate the characterization of unknown genetic regions; 2) illuminate the complexities of gene expression and gene regulation; and 3) aid in the design of key functional experiments. This method will be an asset to genomics, as well as the growing field of pharmacogenomics, because it is the first approach that allows characterization of all possible RNA variants, including very short-lived products that may be refractory to recovery (and characterization) via traditional mechanisms.

In one embodiment, the method for preparing genetic material for analysis comprises (a) screening libraries constructed from artificial chromosomes (such as BAC or PAC) containing genetic regions (loci) of interest with a gene-specific probe, wherein a positively-hybridizing artificial chromosome is indicative of the presence of the gene, a portion of the gene, or a closely-related member of a gene family, in the positively-hybridizing artificial chromosome; (b) transfecting the positively-hybridizing artificial chromosome into a eukaryotic host cell (such as a tumor cell line), thereby generating RNA from transcription of the artificial chromosome's genetic material within the host cell; and (c) isolating the artificial chromosome's RNA from the host cell.

In one embodiment, the method for profiling variations in gene transcription from complex or unknown genomic regions comprises: (a) screening libraries constructed from artificial chromosomes (such as BAC or PAC) containing genetic regions (loci) of interest with a gene-specific probe, wherein a positively-hybridizing artificial chromosome is indicative of the presence of the gene, a portion of the gene, or a closely-related member of a gene family, in the positively-hybridizing artificial chromosome; (b) transfecting the positively-hybridizing artificial chromosome into a eukaryotic host cell (such as a tumor cell line), thereby generating RNA from transcription of the artificial chromosome's genetic material within the host cell; (c) isolating the artificial chromosome's RNA from the host cell; and (d) analyzing the artificial chromosome's RNA to obtain a transcription profile.

### DETAILED DESCRIPTION OF THE INVENTION

The present inventors have been developing and optimizing the method of the invention using BAC and PAC clones that have been previously sequenced and assembled by different genome sequencing centers as well as through the efforts of the inventors. While a specific set of genes is known to reside in these genomic regions, little is known regarding their transcriptional variation (e.g., variable RNA processing).

The present inventors have used several in-house, well-characterized PAC and BAC clones and have been able to identify, using gene-specific primers, a variety of cDNAs, which include both the observed and expected (predicted) versions as well as novel splice variants. It is expected that complete analysis of transcriptional repertoires from specific BAC clones of interest will: 1) facilitate characterizing unknown genetic regions (loci); 2) illuminate the complexities of gene expression and regulation; and 3) aid in the design of key functional experiments. The method of the invention will be an asset to genomics as well as the growing field of pharmacogenomics because it is the first approach that allows characterization of all possible RNA variants, including very short-lived products, that may be refractory to recovery (and characterization) via traditional mechanisms.

In one embodiment, a method of the invention comprises: (a) screening libraries constructed from artificial chromosomes (such as BAC or PAC) containing genetic regions (loci) of interest with a gene-specific probe, wherein a positively-hybridizing artificial chromosome is indicative of the presence of the gene, a portion of the gene (fragment), or a closely-related member of a gene family, in the positively-hybridizing artificial chromosome; (b) transfecting the positively-hybridizing artificial chromosome into a eukaryotic host cell (such as a tumor cell line), thereby generating RNA from transcription of the artificial chromosome's genetic material within the host cell; (c) isolating the artificial chromosome's RNA from the host cell; and, optionally, (d) analyzing the artificial chromosome's RNA to obtain a transcription profile.

Prior to analysis of the artificial chromosome's RNA (mRNA), total RNA is isolated from the lysed host cells from which cDNA is synthesized. Next, the mRNA (represented by cDNA), specific to the artificial chromosome, is isolated from the background, or host-specific RNA, and then cloned into an appropriate vector and sequenced. In addition, the isolated cDNA can be analyzed by PCR using gene specific primers. A major advantage of the “capture-method” described herein is that any type of alternative mRNA transcript, which may include alternative splice products and/or products of a multi-gene family, sharing as little as 60% sequence identity, and/or unrecognized/unpredicted coding regions will be isolated for analysis. Conventional screening methods, using gene-specific primer pairs are intrinsically biased and may fail to reveal the true complement of many genetic regions. This effect is particularly pronounced in genetic regions where certain gene products undergo complex transcriptional regulation (in vivo).

As used herein, the term “complex genomic region” refers to a region containing more than one copy of a gene, such as in a multi-gene family, such that the paralogous members could be functionally diverged and potentially share as little as 60% sequence identity. However, sequence identity between members can be higher, such as 70%, 75%, 80%, 85%, 90%, 95%, or 99%, for example. In addition, the term “complex genomic region” includes those regions that contain alternative splice sites, alternative exons, secondary structure, and/or repeats; all of which can effect the gene products (mRNA) originating from the region. Furthermore, the term “complex genomic regions” encompass unregulated/unpredicted coding regions that only would be revealed by a segment-specific approach such as that described herein. Diverse transcription products, such as these, may not be detected by conventional isolation and analysis methods, which include PCR using gene-specific primers. In addition, because members of a multi-gene family can be functionally divergent, expression of their various gene products could be tightly regulated in vivo. The method of the invention will facilitate the analysis of such products because expression of the genetic region in the cell culture system used in the method is less amenable to regulation.

As used herein, the phrase “closely-related member of a gene family” includes multiple homologous copies of a gene (paralogs) that can exist within a chromosomal region, some of which are functionally divergent. Certain members of such a family could be under various levels of selection and thereby become progressively removed and potentially difficult to recognize in terms of contiguous sequence identity. Therefore, the amount of sequence identity among the members begins to go down. The method of the subject invention allows for the expression, capture, and analysis of multiple members of a gene family.

As used herein, the term “artificial chromosomes” refers to nucleic acid molecules, typically DNA, that stably replicate and segregate alongside endogenous chromosomes in cells and have the capacity to accommodate and express heterologous genes contained therein. Artificial chromosomes have the capacity to act as a gene delivery vehicle by accommodating and expressing foreign genes contained therein.

In various aspects, forms of genomic nucleic acid used in the methods of the invention include genomic DNA, e.g., genomic libraries, contained in mammalian and human artificial chromosomes, satellite artificial chromosomes, yeast artificial chromosomes, bacterial artificial chromosomes, P1 artificial chromosomes, recombinant vectors and viruses, plasmids, and the like.

Mammalian artificial chromosomes (MACs) and human artificial chromosomes (HAC) are, e.g., described in Ascenzioni (1997) Cancer Lett. 118:135-142; Kuroiwa (2000) Nat. Biotechnol. 18:1086-1090; U.S. Pat. Nos. 5,288,625; 5,721,118; 6,025,155; 6,077,697). MACs can contain inserts larger than 400 kilobase (Kb), see, e.g., Mejia (2001) Am. J. Hum. Genet. 69:315-326. Auriche (2001) EMBO Rep. 2:102-107, has built a human minichromosomes having a size of 5.5 kilobase.

Satellite artificial chromosomes, or, satellite DNA-based artificial chromosomes (SATACs), are, e.g., described in Warburton (1997) Nature 386:553-555; Roush (1997) Science 276:38-39; Rosenfeld (1997) Nat. Genet. 15:333-335). SATACs can be made by induced de novo chromosome formation in cells of different mammalian species; see, e.g., Hadlaczky (2001) Curr. Opin. Mol. Ther. 3:125-132; Csonka (2000) J. Cell Sci. 113 (Pt 18):3207-3216.

Yeast artificial chromosomes (YACs) can also be used and typically contain inserts ranging in size from 80 to 700 kb. YACs have been used for many years for the stable propagation of genomic fragments of up to one million base pairs in size; see, e.g., U.S. Pat. Nos. 5,776,745; 5,981,175; Feingold (1990) Proc. Natl. Acad. Sci. USA 87:8637-8641; Tucker (1997) Gene 199:25-30; Adam (1997) Plant J. 11:1349-1358; Zeschnigk (1999) Nucleic Acids Res. 27:21.

Bacterial artificial chromosomes (BACs) are vectors that can contain 120 Kb or greater inserts, see, e.g., U.S. Pat. Nos. 5,874,259; 6,277,621; 6,183,957. BACs are based on the E. coli F factor plasmid system and simple to manipulate and purify in microgram quantities. Because BAC plasmids are kept at one to two copies per cell, the problems of rearrangement observed with YACs, which can also be employed in the present methods, are eliminated; see, e.g., Asakawa (1997) Gene 69-79; Cao (1999) Genome Res. 9:763-774; and Shizuya, H. et al. (1992) Proc. Natl. Acad. Sci. 89: 8794-8797.

P1artificial chromosomes (PACs), bacteriophage P1-derived vectors are, e.g., described in Woon (1998) Genomics 50:306-316; Boren (1996) Genome Res. 6:1123-1130; Ioannou (1994) Nature Genet. 6:84-89; Reid (1997) Genomics 43:366-375; Nothwang (1997) Genomics 41:370-378; Kern (1997) Biotechniques 23:120-124); and Ioannou P. A. et al. (1994) Nat. Genet. 6: 84-89. P1 is a bacteriophage that infects E. coli that can contain 75 to 100 Kb DNA inserts (see, e.g., Mejia (1997) Genome Res 7:179-186; Ioannou (1994) Nat Genet 6:84-89). PACs are screened in much the same way as arrayed EST plasmid libraries. See also Ashworth (1995) Analytical Biochem. 224:564-571; Gingrich (1996) Genomics 32:65-74.

Other cloning vehicles can also be used, such as recombinant viruses, cosmids, plasmids, or cDNAs; see, e.g., U.S. Pat. Nos. 5,501,979; 5,288,641; and 5,266,489.

These vectors can include reporter genes (also referred to herein as “marker genes”), such as, e.g., luciferase and green fluorescent protein genes (see, e.g., Baker (1997) Nucleic Acids Res 25:1950-1956). Sequences, inserts, clones, vectors and the like can be isolated from natural sources, obtained from such sources as ATCC or GenBank libraries or commercial sources, or prepared by synthetic or recombinant methods. Reporter genes encode reporter polypeptides such as beta-globin, chloramphenicol acetyltransferase (CAT), luciferase, and beta-galactosidase (beta-gal). The reporter polypeptide is one whose production can be detected and, optionally, measured qualitatively, quantitatively, and/or semi-quantitatively in cells. More preferably, the reporter polypeptide is one whose production can be detected (and, optionally, measured qualitatively, quantitatively, and/or semi-quantitatively) in living, intact cells. Examples of such reporter polypeptides include fluorescent polypeptides (also referred to herein as fluorescent proteins (FP)) such as the green fluorescent proteins (GFP), and variants of GFP such as yellow fluorescent proteins (YFP), etc., for example, PS-FP (Yang F. et al., Nat. Biotechno., 1996, 10:1246-1251; Cubitt A. B. et al., “Understanding Structure-Function Relationships in the Aequorea victoria Green Fluorescent Protein, in Methods in Cell Biology, Vol. 58, Green Fluorescent Protein, Academic Press, 1999:19-29; Kain S. R., “Enhanced Variants of the Green Fluorescent Protein for Greater Sensitivity, Different Colours and Detection of Apoptosis”, in Fluorescent and Luminescent Probes, 2^{nd} Edition, 1999, Chapter 19:284-292; Tsien R. Y., Annu. Rev. Biochem., 1998, 67:509-544; Eisenstein, M., Nature Methods, January 2005, Research Highlights, 2(1):8-9; each of which is incorporated herein in its entirety). As used herein, “variants of GFP” include, but are not limited to, polypeptides known in the art as green fluorescent protein-like proteins, GFP-like chromoproteins, green fluorescent protein fragments, red fluorescent proteins, and orange fluorescent proteins.

The LUMIO recognition sequence is a small, six-amino acid sequence (Cys-Cys-Pro-Gly-Cys-Cys; SEQ ID NO:1) useful for site-specific fluorescence labeling and detection of proteins in live mammalian cells (Mammalian LUMIO GATEWAY vector (INVITROGEN; e.g., catalog nos. 12589-016, 12589-024, and 12589-032; see, for example INVITROGEN life technologies Instruction Manual, Version C, 7 Dec. 2004; Tour 0. et al., Nat. Biotechnol., 2003, 21(12):1505-1508, which is incorporated herein by reference in its entirety)). This unique sequence rarely appears in endogenous proteins, providing precise detection of proteins with this fusion tag. The LUMIO detection reagents bind this sequence with high specificity and affinity, resulting in a bright fluorescent signal. A number of LUMIO vectors are available from INVITROGEN, allowing a variety of applications in multiple host systems. Cloning and in vitro transcription of GFP fusion constructs is well known in the art and may be used to carry out the present invention (Oancea E. et al., J. Cell Biology, 1998, 140(3):485-498, which is incorporated herein by reference in its entirety).

In addition, the vectors of the present invention may optionally include another marker gene such as an antibiotic resistance gene and the fluorescent protein is used here as a visualization marker gene for example, FP/PS1/Ble, to aid visualization and fluorescent quantitation of the protein. Many FPs, originally isolated from the jellyfish Aequorea Victoria (for example, GFP) retain their fluorescent properties when expressed in heterologous cells, thereby providing a powerful tool as fluorescent recombinant probes to monitor cellular events or functions (see, for example, Chalfie et al., Science, 1994, 263(5148):802-805; Prasher, Trends Genet., 1995, 11(8):320-3; and PCT publication no. WO 95/07463, each of which is incorporated herein by reference in its entirety).

Several spectral and mutational variants of GFP proteins have been isolated, for example, the naturally occurring blue-fluorescent variant of GFP (Heim et al., Proc. Natl. Acad. Sci. USA, 1994, 91(26):12501-4; U.S. Pat. No. 6,172,188, both of which are incorporated herein by reference), the yellow-fluorescent protein variant of GFP (Miller et al., J. Mol. Biol., 1999, 288:975-987; Weiss, et al., Proc. Natl. Acad. Sci. USA, 2001, 98(26):14961-62001; Majoul, et al., Dev. Cell., 2001, 1(1):139-53; Laird et al., Microsc. Res. Tech., 2001;52(3):263-72; Daabrowski et al., Protein Expr. Purif, 1999, 16(2):315-23, and more recently the red fluorescent protein isolated from the coral Discosoma (Fradkov et al., FEBS Lett., 2000, 479(3):127-30; Miller et al., J. Mol. Biol., 1999, 288:975-987), which allows the use of fluorescent probes having different excitation and emission spectra permitting the simultaneous monitoring of more than one process. GFP proteins provide non-invasive assays that allow detection of cellular events in intact, living cells. The skilled artisan will recognize that the invention is not limited to the fluorescent polypeptides explicitly described herein and one may use any other spectral or mutational variant or derivative as a reporter polypeptide in accordance with the present invention.

The method of the invention may require the enzymatic amplification of nucleic acid fragments. Such an amplification reaction may comprise any suitable DNA amplification reaction known to the art. “DNA amplification” as used herein refers to any process that increases the number of copies of a specific DNA sequence by enzymatically amplifying the nucleic acid sequence. A variety of processes are known. One of the most commonly used is the polymerase chain reaction (PCR). The PCR process of Mullis is described in U.S. Pat. Nos. 4,683,195 and 4,683,202. PCR involves the use of a thermostable DNA polymerase, known sequences as primers, and heating cycles, which separate the replicating deoxyribonucleic acid (DNA), strands and exponentially amplify a gene of interest. Any type of PCR, such as quantitative PCR, RT-PCR, hot start PCR, LAPCR, multiplex PCR, touchdown PCR, extension PCR, etc., may be used. In general, the PCR amplification process involves an enzymatic chain reaction for preparing exponential quantities of a specific nucleic acid sequence. It requires a small amount of a sequence to initiate the chain reaction and oligonucleotide primers that will hybridize to the sequence. In PCR, the primers are annealed to denatured nucleic acid followed by extension with an inducing agent (enzyme) and nucleotides. This results in newly synthesized extension products. Since these newly synthesized sequences become templates for the primers, repeated cycles of denaturing, primer annealing, and extension results in exponential accumulation of the specific sequence being amplified. The extension product of the chain reaction will be a discrete nucleic acid duplex with a termini corresponding to the ends of the specific primers employed.

The terms “enzymatically amplify” or “amplify” are intended to mean, DNA amplification, i.e., a process by which nucleic acid sequences are amplified in number. There are several means for enzymatically amplifying nucleic acid sequences. Currently, the most commonly used method is the polymerase chain reaction (PCR). Other amplification methods include LCR (ligase chain reaction) which utilizes DNA ligase, and a probe consisting of two halves of a DNA segment that is complementary to the sequence of the DNA to be amplified, enzyme QB replicase and a ribonucleic acid (RNA) sequence template attached to a probe complementary to the DNA to be copied which is used to make a DNA template for exponential production of complementary RNA; strand displacement amplification (SDA); Qbeta replicase amplification (QbetaRA); self-sustained replication (3SR); and NASBA (nucleic acid sequence-based amplification), which can be performed on RNA or DNA as the nucleic acid sequence to be amplified.

“Polymerase chain reaction” or “PCR” refers to a thermocyclic, polymerase-mediated, DNA amplification reaction. A PCR typically includes template molecules, oligonucleotide primers complementary to each strand of the template molecules, a thermostable DNA polymerase, and deoxyribonucleotides, and involves three distinct processes that are repeated to effect the amplification of the original nucleic acid. The three processes (denaturation, hybridization, and primer extension) are often performed at distinct temperatures, and in distinct temporal steps. In many embodiments, however, the hybridization and primer extension processes can be performed concurrently. The nucleotide sample to be analyzed may be PCR amplification products provided using the rapid cycling techniques described in U.S. Pat. Nos. 6,569,672; 6,569,627; 6,562,298; 6,556,940; 6,569,672; 6,569,627; 6,562,298; 6,556,940; 6,489,112; 6,482,615; 6,472,156; 6,413,766; 6,387,621; 6,300,124; 6,270,723; 6,245,514; 6,232,079; 6,228,634; 6,218,193; 6,210,882; 6,197,520; 6,174,670; 6,132,996; 6,126,899; 6,124,138; 6,074,868; 6,036,923; 5,985,651; 5,958,763; 5,942,432; 5,935,522; 5,897,842; 5,882,918; 5,840,573; 5,795,784; 5,795,547; 5,785,926; 5,783,439; 5,736,106; 5,720,923; 5,720,406; 5,675,700; 5,616,301; 5,576,218 and 5,455,175, the disclosures of which are incorporated by reference in their entireties. It is understood that, in any method for producing a polynucleotide containing given modified nucleotides, one or several polymerases or amplification methods may be used. The selection of optimal polymerization conditions depends on the application.

A “fragment” of a molecule such as a protein or nucleic acid sequence is meant to refer to any portion of the amino acid or nucleotide sequence. The term “expressed sequence tags” or “ESTs” refers to contiguous DNA sequences obtained by sequencing stretches of cDNAs (see, for example, WO 93/00353). In principle, the ESTs may be used to isolate or purify extended cDNAs that include sequences adjacent to the EST sequences. These extended cDNAs may contain portions or the full coding sequence of the gene from which the EST was derived.

A linear sequence of nucleotides is “essentially identical” to another linear sequence, if both sequences are capable of hybridizing to form a duplex with the same complementary polynucleotide. The term “hybridize” as applied to a polynucleotide refers to the ability of the polynucleotide to form a complex that is stabilized via hydrogen bonding between the bases of the nucleotide residues in a hybridization reaction. The hydrogen bonding may occur by Watson-Crick base pairing, Hoogstein binding, or in any other sequence-specific manner. The complex may comprise two strands forming a duplex structure, three or more strands forming a multi-stranded complex, a single self-hybridizing strand, or any combination of these. The hybridization reaction may constitute a step in a more extensive process, such as the initiation of a PCR reaction, or the enzymatic cleavage of a polynucleotide by a ribozyme.

Hybridization can be performed under conditions of different “stringency.” Relevant conditions include temperature, ionic strength, time of incubation, the presence of additional solutes in the reaction mixture such as formamide, and the washing procedure. Higher stringency conditions are those conditions, such as higher temperature and lower sodium ion concentration, which require higher minimum complementarity between hybridizing elements for a stable hybridization complex to form. In general, a low stringency hybridization reaction is carried out at about 40° C. in about 10×SSC or a solution of equivalent ionic strength/temperature. A moderate stringency hybridization is typically performed at about 50° C. in about 6×SSC, and a high stringency hybridization reaction is generally performed at about 60° C. in about 1×SSC.

Sequences that hybridize under conditions of greater stringency are more preferred. As is apparent to one skilled in the art, hybridization reactions can accommodate insertions, deletions, and substitutions in the nucleotide sequence. Thus, linear sequences of nucleotides can be essentially identical even if some of the nucleotide residues do not precisely correspond or align. In general, essentially identical sequences of about 60 nucleotides in length will hybridize at about 50° C. in 10×SSC; preferably, they will hybridize at about 60° C. in 6×SSC; more preferably, they will hybridize at about 65° C. in 6×SSC; even more preferably, they will hybridize at about 70° C. in 6×SSC, or at about 40° C. in 0.5×SSC, or at about 30° C. in 6×SSC containing 50% formamide; still more preferably, they will hybridize at 40° C. or higher in 2×SSC or lower in the presence of 50% or more formamide. It is understood that the rigor of the test is partly a function of the length of the polynucleotide; hence, shorter polynucleotides with the same homology should be tested under lower stringency and longer polynucleotides should be tested under higher stringency, adjusting the conditions accordingly. The relationship between hybridization stringency, degree of sequence-identity, and polynucleotide length is known in the art and can be calculated by standard formulae. An extensive guide to the hybridization of nucleic acids is found in Tijssen, Techniques in Biochemistry and Molecular Biology—Hybridization with Nucleic Probes, “Overview of principles of hybridization and the strategy of nucleic acid assays” (1993), which is incorporated herein by reference in its entirety.

Sequence homology or identity can also be determined with the aid of computer methods. A variety of sequence analysis software programs are available in the art. Non-limiting examples of these programs are Bestfit program (Wisconsin Sequence Analysis Package, Genetics Computer Group, Madison Wis.), Fasta (Wisconsin Sequence Analysis Package, Genetics Computer Group, Madison Wis.), Blast (http://www.ncbi.nlm.nih.gov/BLAST/), DNA Star, MegAlign, GeneJocky, and SAM (Hughey et al. (1995) Technical Report UCSC-CRL-95-7, University of California, Santa Cruz, Computer Engineering). Sequence similarity is typically discerned by comparing a query sequence (polynucleotide or polypeptide sequence) to a reference sequence or a plurality of reference sequences contained in a database. Any public or proprietary sequence databases that contain DNA or protein sequences corresponding to a gene or a segment thereof can be used for sequence analysis. Commonly employed databases include but are not limited to GenBank, EMBL, DDBJ, PDB, SWISS-PROT, EST, STS, GSS, and HTGS. Common parameters for determining the extent of homology set forth by one or more of the aforementioned alignment programs include p value and percent sequence identity. P value is the probability that the alignment is produced by chance. For a single alignment, the p value can be calculated according to Karlin et al. (1990) Proc. Natl. Acad. Sci 87: 2264-2268. For multiple alignments, the p value can be calculated using a heuristic approach such as the one programmed in Blast. Percent sequence identity is defined by the ratio of the number of nucleotide or amino acid matches between the query sequence and the reference when the two are optimally aligned.

In carrying out the method of the invention, polynucleotides can be inserted into a suitable gene delivery vehicle, and the vehicle in turn can be introduced into a suitable host cell for replication and amplification. Gene delivery vehicles include both viral and non-viral vectors. Non-limiting examples of gene delivery vehicles are liposomes, plasmid, bacteriophage, cosmid, fungal vectors, viruses, such as adenovirus, baculovirus, and retrovirus, and any other recombination vehicles capable of carrying an inserted polynucleotide into a host cell.

Vectors are generally categorized into cloning and expression vectors. Cloning vectors are useful for obtaining replicate copies of the polynucleotides they contain, or as a means of storing the polynucleotides in a depository for future recovery. Expression vectors (and host cells containing these expression vectors) can be used to obtain polypeptides produced from the polynucleotides they contain. Suitable cloning and expression vectors include any known in the art, e.g., those for use in bacterial, mammalian, yeast and insect expression systems. The polypeptides produced in the various expression systems are also within the scope of the invention.

Cloning and expression vectors typically contain a selectable marker (for example, a gene encoding a protein necessary for the survival or growth of a host cell transformed with the vector), although such a marker gene can be carried on another polynucleotide sequence co-introduced into the host cell. Only those host cells into which a selectable gene has been introduced will grow under selective conditions. Typical selection genes either: (a) confer resistance to antibiotics or other toxins, e.g., ampicillin, neomycin, methotrexate; (b) complement auxotrophic deficiencies; or (c) supply critical nutrients not available from complex media. The choice of the proper marker gene will depend on the host cell, and appropriate genes for different hosts are known in the art. Vectors also typically contain a replication system recognized by the host.

Suitable cloning vectors can be constructed according to standard techniques, or selected from a large number of cloning vectors available in the art. While the cloning vector selected may vary according to the host cell intended to be used, useful cloning vectors will generally have the ability to self-replicate, may possess a single target for a particular restriction endonuclease, or may carry marker genes. Suitable examples include plasmids and bacterial viruses, e.g., pBR322, pMB9, ColE1, pCR1, RP4, pUC18, mp18, mp19, phage DNAs, and shuttle vectors such as pSA3 and pAT28. These and other cloning vectors are available from commercial vendors such as STRATAGENE, CLONTECH, BIORAD, and INVITROGENE.

A “label” is a molecule, compound, or composition detectable by spectroscopic, photochemical, biochemical, immunochemical, or chemical means. For example, useful labels include ³²P, fluorescent dyes, electron-dense reagents, enzymes (e.g., as commonly used in an ELISA), biotin, digoxigenin, or haptens and proteins for which antisera or monoclonal antibodies are available (e.g., a polypeptide can be made detectable, for example, by incorporating a radiolabel into the peptide, and used to detect antibodies specifically reactive with the peptide).

The method of the subject invention involves screening libraries constructed from artificial chromosomes containing genetic regions of interest with a gene-specific nucleic acid probe. As used herein a “nucleic acid probe or oligonucleotide” is defined as a nucleic acid capable of binding to a target nucleic acid of complementary sequence through one or more types of chemical bonds, usually through complementary base pairing, usually through hydrogen bond formation. A short oligonucleotide sequence may be based on, or designed from, a genomic or cDNA sequence and is used to amplify, confirm, or reveal the presence of an identical, similar or complementary DNA or RNA in a particular cell or tissue. Oligonucleotides may be chemically synthesized and may be used as primers or probes. Oligonucleotide means any nucleotide of more than 3 bases in length used to facilitate detection or identification of a target nucleic acid, including probes and primers.

“Probes” refer to oligonucleotides of variable length, used in the detection of identical, similar, or complementary nucleic acid sequences by hybridization. As used herein, a probe may include natural (i.e., A, G, C, or T) or modified bases (7-deazaguanosine, inosine, etc.). In addition, the bases in a probe may be joined by a linkage other than a phosphodiester bond, so long as it does not interfere with hybridization. Thus, for example, probes may be peptide nucleic acids in which the constituent bases are joined by peptide bonds rather than phosphodiester linkages. It will be understood by one of skill in the art that probes may bind target sequences lacking complete complementarity with the probe sequence depending upon the stringency of the hybridization conditions. An oligonucleotide sequence used as a detection probe may be labeled with a detectable moiety. Thus, a “labeled nucleic acid probe or oligonucleotide” is one that is bound, either covalently, through a linker or a chemical bond, or noncovalently, through ionic, van der Waals, electrostatic, or hydrogen bonds to a label such that the presence of the probe may be detected by detecting the presence of the label bound to the probe. Various labeling moieties are known in the art. The labeling moiety may be, for example, a radioactive compound, a detectable enzyme (e.g., horse radish peroxidase (HRP)) or any other moiety capable of generating a detectable signal such as a calorimetric, fluorescent, chemiluminescent or electrochemiluminescent signal. The detectable moiety may be detected using known methods. The probes are preferably directly labeled as with isotopes, chromophores, lumiphores, chromogens, or indirectly labeled such as with biotin to which a streptavidin complex may later bind. By assaying for the presence or absence of the probe, one can detect the presence or absence of the selected sequence or subsequence.

The method of the subject invention involves transfecting the positively-hybridized artificial chromosome into a host cell (such as a tumor cell line). The terms “transfection” and “transformation”, and grammatical variations thereof, are used interchangeably to refer to introduction of the genetic material into the host cell by any gene delivery technique, such as lipid delivery using cationic lipids, viral delivery, electroporation, or other chemical modes (such as calcium phosphate precipitation, DEAE-dextran, or polybrene). The term “host cells” refers to eukaryotic cells which can be, or have been, used as recipients for the positively-hybridized artificial chromosome, immaterial of the method by which the genetic material is introduced into the cell or the subsequent disposition of the cell. The terms include the progeny of the original cell that has been transfected. Cells in primary culture can also be used as recipients. Host cells can range in plasticity and proliferation potential. Host cells can be differentiated cells, progenitor cells, or stem cells, for example. The host cells can be cultured in conventional nutrient media modified as appropriate for activating promoters, selecting transformants/transfectants or amplifying the transferred genetic material. The culture conditions, such as temperature, pH and the like, generally are similar to those previously used with the host cell selected for expression, and will be apparent to those of skill in the art.

Eukaryotic hosts include yeast and mammalian cells in culture systems. Pichia pastoris, Saccharomyces cerevisiae and S. carlsbergensis are commonly used yeast hosts. Methods for introducing exogenous DNA into yeast hosts are available in the art, and usually include either the transformation of spheroplasts or of intact yeast cells treated with alkali cations. Transformation procedures usually vary with the yeast species to be transformed (Kurtz et al., Mol. Cell. Biol., 1986, 6:142; Kunze et al., J. Basic Microbiol., 1985, 25:141 [Candida], Gleeson et al., J. Gen. Microbiol., 1986, 132:3459; Roggenkamp et al., Mol. Gen. Genet., 1986, 202:302 [Hansenula], Das et al., J. Bacteriol., 1984, 158:1165; De Louvencourt et al., J. Bacteriol., 1983, 754:737; Van den Berg et al., Bio/Technology, 1990, 8:135 (1990) [Kluyveromyces], Cregg et al., Mol. Cell. Biol., 1985, 5:3376; Kunze et al., J. Basic Microbiol., 1985, 25:141; U.S. Pat. Nos. 4,837,148 and 4,929,555 [Pichia], Hinnen et al., Proc. Natl. Acad. Sci. USA, 1978, 75:1929; Ito et al., J. Bacteriol., 1983, 153:163 [Saccharomyces], Beach and Nurse, Nature, 1981, 300:706 [Schizosaccharomyces], and Davidow et al., Curr. Genet., 1985, 10:39; Gaillardin et al., Curr. Genet., 1985, 10:49 [Yarrowia]). Yeast-compatible vectors can carry markers that permit selection of successful transformants by conferring protrophy to auxotrophic mutants or resistance to heavy metals on wild-type strains. Yeast compatible vectors may employ the 2-μ origin of replication (Broach et al. Meth. Enzymol., 1983, 101:307), the combination of CEN3 and ARS1 or other means for assuring replication, such as sequences that will result in incorporation of an appropriate fragment into the host cell genome. Control sequences for yeast vectors are known in the art and include but are not limited to promoters for the synthesis of glycolytic enzymes, including the promoter for 3-phosphoglycerate kinase. (See, for example, Hess et al. J. Adv. Enzyme Reg., 1968, 7:149; Holland et al. Biochemistry, 1978, 17:4900; and Hitzeman J. Biol. Chem., 1980, 255:2073).

Methods for introduction of heterologous genetic material into mammalian cells are known in the art and, as indicated above, include. lipid-mediated transfection, encapsulation of the polynucleotide(s) in liposomes, dextran-mediated transfection, calcium phosphate precipitation, polybrene-mediated transfection, electroporation, as well as protoplast fusion, biollistics, and direct microinjection of the DNA into nuclei. The choice of method depends on the cell being transformed as certain transformation methods are more efficient with one type of cell than another (Felgner et al., Proc. Natl. Acad Sci., 1987, 84:7413; Felgner et al., J. Biol. Chem., 1994, 269:2550; Graham and van der Eb, Virology, 1973, 52:456; Vaheri and Pagano, Virology, 1965, 27:434; Neuman et al., EMBO J., 1982, 1:841; Zimmerman, Biochem. Biophys. Acta., 1982, 694:227; Sanford et al., Methods Enzymol., 1993, 217:483; Kawai and Nishizawa, Mol. Cell. Biol., 1984, 4:1172; Chaney et al., Somat. Cell Mol. Genet., 1986, 12:237; Aubin et al., Methods Mol. Biol., 1997, 62:319). In addition, many commercial kits and reagents for transfection of eukaryotic cells are available. Exogenous DNA can be conveniently introduced into insect cells through use of recombinant viruses, such as the baculoviruses.

Host cells useful for transfection with the positively-hybridized artificial chromosome's genetic material may be primary cells or cells of cell lines. The host cells may be tumor cells or non-tumor cells. Mammalian cell lines available as hosts for expression are known in the art and are available from depositories such as the American Type Culture Collection. These include but are not limited to HeLa cells (Macville et al., Cancer Res., 1999, 59:141-150), human embryonic kidney (HEK) 293 cells (Graham et al., J. Gen. Virol., 1977, 36:59-74), Chinese hamster ovary (CHO) cells (e.g., CHO-K1), and baby hamster kidney (BHK) cells (e.g., BHK-21) (Hayakawa et al., Biologicals, 1992, 20:253-257). Other specific examples of cells include A-431, AS-52, CV-1, H187, mouse L cells, Jurkat, COS-7, Mono-Mac-6, L6, L-132, NIH/3T3, HaCaT, EA.hy926, HEPG2, HC 11, MDCK, and HL-60.

As indicated above, following transfection of the genetic material into a cell, the cell may be selected for the presence of the genetic material through use of a selectable marker. A selectable marker is generally encoded on the nucleic acid being introduced into the recipient cell. However, co-transfection of a selectable marker can also be used during introduction of nucleic acid into a host cell. Selectable markers that can be expressed in the recipient host cell may include, but are not limited to, genes that render the recipient host cell resistant to drugs. Selectable markers may also include biosynthetic genes. Upon transfection of a host cell, the cell can be placed into contact with an appropriate selection agent.

As described above, the methods of the invention can be used to express large genomic segments, which are housed in artificial chromosome clones (e.g., PAC or BAC clones), and presumably contain a genetic region of interest, in a eukaryotic host cell. In one embodiment, the primary host cell line is a human embryonic kidney tumor line (e.g., HEK 293T). The tumor line produces a large array of transcription activation factors that recognize genetic regions of the artificial chromosome (e.g., PAC or BAC) and begin to transcribe the RNA from the gene. The method is carried out in live eukaryotic cells, as apposed to a cell free in vitro assay, so that one can expect that much of the native transcripts will be produced. In the closed system, as is the case in culture, one is more likely to capture all variants (transcriptional) of the mRNA that would result from the genetic region. Therefore, by expressing a full genomic gene locus (as opposed to an altered recombinant cDNA), the researcher can analyze the potential array of transcriptional variants that are possible in vivo (live organism) since most of the splice and cryptic splice sites tend to be readily recognized by the appropriate culture system. The researcher then has a variety of options as to how the RNA is captured and recovered from the system. The final method of analysis can involve PCR and/or direct sequencing of captured and eluted, reverse transcribed, and cloned products.

The terms “isolated,” “purified,” or “biologically pure” refer to material that is substantially or essentially free from components which normally accompany it as found in its native state. Purity and homogeneity are typically determined using analytical chemistry techniques such as polyacrylamide gel electrophoresis or high performance liquid chromatography. A protein that is the predominant species present in a preparation is substantially purified. The term “purified” denotes that a nucleic acid or protein gives rise to essentially one band in an electrophoretic gel. Particularly, it means that the nucleic acid or protein is at least 85% pure, more preferably at least 95% pure, and most preferably at least 99% pure.

“Nucleic acid” or “nucleic acid molecule” refers to deoxyribonucleotides or ribonucleotides and polymers thereof in either single-stranded or double-stranded form. The term encompasses nucleic acids containing known nucleotide analogs or modified backbone residues or linkages, which are synthetic, naturally occurring, and non-naturally occurring, which have similar binding properties as the reference nucleic acid, and which are metabolized in a manner similar to the reference nucleotides. Examples of such analogs include, without limitation, phosphorothioates, phosphoramidates, methyl phosphonates, chiral-methyl phosphonates, 2-O-methyl ribonucleotides, peptide-nucleic acids (PNAs).

The term “DNA” refers to the polymeric form of deoxyribonucleotides (adenine, guanine, thymine, or cytosine) in either single stranded form, or as a double-stranded helix. This term refers only to the primary and secondary structure of the molecule, and does not limit it to any particular tertiary forms. In discussing the structure of particular double-stranded DNA molecules, sequences may be described herein according to the normal convention of giving only the sequence in the 5′ to 3′ direction along the non-transcribed strand of DNA (i.e., the strand having a sequence homologous to the mRNA).

Unless otherwise indicated, a particular nucleic acid sequence also implicitly encompasses conservatively modified variants thereof (e.g., degenerate codon substitutions) and complementary sequences, as well as the sequence explicitly indicated. The term nucleic acid is used interchangeably with gene, cDNA, mRNA, oligonucleotide, and polynucleotide.

The terms “polypeptide,” “peptide” and “protein” are used interchangeably herein to refer to a polymer of amino acid residues of any length. The terms apply to amino acid polymers in which one or more amino acid residue is an analog or mimetic of a corresponding naturally occurring amino acid, as well as to naturally occurring amino acid polymers. Polypeptides can be modified, e.g., by the addition of carbohydrate residues to form glycoproteins. The terms “polypeptide,” “peptide”, and “protein” include glycoproteins, as well as non-glycoproteins.

The term “gene” refers to a nucleic acid (e.g., DNA or RNA) sequence that comprises coding sequences necessary for the production of an RNA, or a polypeptide or its precursor. A functional polypeptide can be encoded by a full length coding sequence or by any portion of the coding sequence as long as the desired activity or functional properties (e.g., enzymatic activity, ligand binding, signal transduction, etc.) of the polypeptide are retained. The term “portion” when used in reference to a gene refers to fragments of that gene. The fragments may range in size from a few nucleotides to the entire gene sequence minus one nucleotide. Thus, “a nucleotide sequence comprising at least a portion of a gene” may comprise fragments of the gene or the entire gene or genes.

The term “gene” also encompasses the coding regions of a structural gene and includes sequences located adjacent to the coding region on both the 5′ and 3′ ends for a distance of about 1 kb on either end such that the gene corresponds to the length of the full-length mRNA. The sequences which are located 5′ of the coding region and which are present on the mRNA are referred to as 5′ non-translated or untranslated sequences. The sequences which are located 3′ or downstream of the coding region and which are present on the mRNA are referred to as 3′ non-translated or untranslated sequences. The term “gene” encompasses both cDNA and genomic forms of a gene. A genomic form or clone of a gene contains the coding region interrupted with non-coding sequences termed “introns” or “intervening regions” or “intervening sequences.” Introns are segments of a gene which are transcribed into nuclear RNA (hnRNA); introns may contain regulatory elements such as enhancers. Introns are removed or “spliced out” from the nuclear or primary transcript; introns, therefore, are absent in the messenger RNA (mRNA) transcript. The mRNA functions during translation to specify the sequence or order of amino acids in a nascent polypeptide. The term “genetic region of interest” refers to a nucleic acid sequence that may comprise a gene, a portion of a gene, and/or non-coding sequences.

The terms “comprising”, “consisting of”, and “consisting essentially of” are defined according to their standard meaning. The terms may be substituted for one another throughout the instant application in order to attach the specific meaning associated with each term.

As used herein, the singular forms “a”, “an”, and “the” include plural reference unless the context clearly dictates otherwise. Thus, for example, a reference to “a BAC fragment”includes more than one such fragment. A reference to a “PAC clone” includes more than one such clone, and so forth.

Unless otherwise defined, all technical and scientific terms used herein have the same meaning as commonly understood by one of ordinary skill in the art of molecular biology. Although methods and materials similar or equivalent to those described herein can be used in the practice or testing of the present invention, suitable methods and materials are described herein.

The practice of the present invention can employ, unless otherwise indicated, conventional techniques of molecular biology, microbiology, recombinant DNA technology, electrophysiology, and pharmacology that are within the skill of the art. Such techniques are explained fully in the literature (see, e.g., Sambrook, Fritsch & Maniatis, Molecular Cloning: A Laboratory Manual, Second Edition (1989); DNA Cloning, Vols. I and II (D. N. Glover Ed. 1985); Perbal, B., A Practical Guide to Molecular Cloning (1984); the series, Methods In Enzymology (S. Colowick and N. Kaplan Eds., Academic Press, Inc.); Transcription and Translation (Hames et al. Eds. 1984); Gene Transfer Vectors For Mammalian Cells (J. H. Miller et al. Eds. (1987) Cold Spring Harbor Laboratory, Cold Spring Harbor, N.Y.); Scopes, Protein Purification: Principles and Practice (2nd ed., Springer-Verlag); and PCR: A Practical Approach (McPherson et al. Eds. (1991) IRL Press)), each of which are incorporated herein by reference in their entirety.

Following are examples that illustrate materials, methods, and procedures for practicing the invention. The examples are illustrative and should not be construed as limiting.

### EXAMPLE 1

Selecting the BAC/PAC Clone of Interest

Commercial sources of BAC or PAC genomic libraries and archived clones are available for a wide range of animal species and genetically defined animal strains. The usual procedure is to purchase a set of filters representing (multiple genome representation) the library (DNA from each clone is robotically spotted on these nylon filters which can be screened many times) and then screen the library by hybridization with a specific probe of interest. The positive clone(s) can then be identified and purchased from a commercial source. The clone is grown up (cultured) and the BAC DNA isolated for further analysis. At this point, a restriction digest of the PAC/BAC DNA can be hybridized (using e.g., Southern hybridization) to confirm that the gene or locus of interest is present in this clone. The hybridization reactions may be carried out in a filter-based format, in which the target nucleic acids are immobilized on nitrocellulose or nylon membranes and probed with oligonucleotide probes. Any of the known hybridization formats may be used, including Southern blots, slot blots, “reverse” dot blots, solution hybridization, solid support based sandwich hybridization, bead-based, silicon chip-based and microtiter well-based hybridization formats. The detection oligonucleotide probes can range in size between 10-1,000 bases. In order to obtain the required target discrimination using the detection oligonucleotide probes, the hybridization reactions are generally run between 20-60° C., and most preferably between 30-50° C. As known to those skilled in the art, optimal discrimination between perfect and mismatched duplexes is obtained by manipulating the temperature and/or salt concentrations or inclusion of formamide in the stringency washes.

The DNA insert size also can be estimated using pulse field electrophoresis or contour-clamped homogenous electric field (CHEF) analysis (Chu, G. et al., (1986), Science, 234, 1582-1585; Chu, G. (1990), Pulsed-field electrophoresis: theory and practice. In Methods: A Companion to Methods of Enzymology. Pulsed-Field Electrophoresis (B. Birren and E. Lai, eds.), Vol. 1, No. 2, pp. 129-142. Academic Press, San Diego).

### EXAMPLE 2

Preparing the BAC/PAC for cDNA Capture

The identified clone is grown up (cultured, larger scale) and the BAC or PAC can be isolated as a large “maxi-prep” using a commercially available kit, such as NUCLEOBOND DNA purification kits (BD BIOSCIENCES).

### EXAMPLE 3

Expressing in Culture

The present inventors have chosen to express the purified BAC or PAC DNA in a human embryonic kidney 293 cell line, which is derived from embryonic kidney cells immortalized with adenovirus (Graham FL et al., J Gen Virol 1977; 36:59-74). This routinely employed cell line expresses an extraordinary variety of transcription factors such that many expression vectors efficiently express their products. Recent microarray studies of 293 cells have shown that although they were derived from embryonic kidney, they demonstrate many phenotypic characteristics of neuronal progenitors (Shaw G. et al., FASEB J, 2002, 16:869-71). Neuronal tissues are known to express a particularly broad range of transcription factors (and cDNA sequences).

The vector backbone for BACs and PACs are relatively simple and possess both antibiotic resistance and cloning sites but are not engineered to express genes coded within the BAC/PAC insert region. The transcriptional machinery of 293 cells recognizes native promoter elements in several PACs and BACs that the present inventors have expressed, allowing the recovery of cDNA transcripts that are properly spliced, as well as others that appear to represent non-conventional splice forms.

The present inventors have expressed invertebrate and fish DNA in a human cell line; therefore, it is not difficult to differentiate endogenous from expressed transcripts. Alternative cell lines likely to facilitate the expression of human BACs may also be used, e.g., in a mouse cell line, such as NIH 3T3 (Jainchill, J. Virol., 1969, 4:549; Aaronsen et al., J. Cell Physiol., 1968, 72:41; and Copeland et al., Cell, 1979, 16:347). Tracking transfection efficiency can be achieved by co-transfecting the cells with another vector containing a recombinant green fluorescent protein (GFP) gene, or other marker gene(s). Simple modifications of the BAC and PAC vectors may allow greatly increased transfection efficiency.

### EXAMPLE 4

Collecting and Preparing RNA

At set time points, typically 48, 72, or 96 hours post-transfection, cells are lysed with guanidine-based RNA isolation reagents. Complementary DNA (cDNA) is synthesized. During optimization studies, the present inventors have focused on three versions of cDNA production in the attempt to increase efficiency and consistency of transcript capture. Capture of a variety of cDNAs is dependent on several factors, one of which is the method used to make the cDNAs. The present inventors are testing the efficiency of the use of SMART cDNA synthesis (CLONTECH), general double-stranded adaptor-ligated cDNAs, and cDNAs made via a modified oligo-dT primed vector. An important part of the procedure is the ability to successfully, efficiently, and consistently amplify and clone the captured cDNAs. This is achieved when specifically modified ends are ligated to the cDNAs at the initiation of the cDNA production reaction. Double stranded adaptors, SMART ends, or T7/T3 priming sites from within the vector of the oligo-dT vector-priming method, are workable alternatives and the inventors are optimizing these three methods simultaneously and anticipate that more than one method will be used routinely. The end-user can determine which cDNA method is best; cDNAs should be amplifiable before and after the selection experiments.

### EXAMPLE 5

Capture of cDNAs

Double-stranded cDNAs can be amplified, if necessary, prior to capture. The BAC or PAC clone is then prepared for capture by one of two methods derived from original independent descriptions (Parimoo S. et al., Proc Natl Acad Sci USA, 1991, 88:9623-9627; Lovett M et al., Proc. Natl Acad Sci USA, 1991, 88:9628-9632) for conventional cDNA capture from libraries using BAC clones. The BAC or PAC clone is used as a tool to capture cDNAs that complement a significant portion of the genomic sequences found within BAC or PAC DNA. Two methods can be used to prepare the BAC or PAC DNA for capturing BAC or PAC-specific cDNAs expressed in the human 293 cells. In one method, the DNA is biotinylated (modified from Simmons AD et al., Meth Enzymol, 1999; 303:111-126) using one of various methods. A random priming approach is preferred, with random hexamers, Klenow polymerase, and dNTPs where dCTP is replaced with biotin-dCTP. In another method, the DNA is spotted on small (e.g., 3 mm) pieces of nylon discs and cross-linked (Parimoo S. et al., 1991).

For the biotinylated DNA approach, the biotin-DNA BAC fragments are hybridized first with the cDNAs for 48-52 hours at 65° C. The hybridized cDNAs are captured with streptavidin-conjugated magnetic beads, which allow high-efficiency capture and elution of biotinylated products because of the extremely high-affinity of avidin for biotin. The eluted products are amplified using, for example, PCR, the amplicons are cloned into appropriate vectors, and their sequences are characterized.

An alternative approach involves spotting the unlabeled BAC or PAC DNA onto small nylon discs and placing this disc directly into the cDNA mix, which is then hybridized for the appropriate time at the optimal temperature. After hybridization, the disc is recovered, washed, and then directly PCR-amplified. The resulting hybridized cDNAs are recovered by PCR. The disc method also is particularly useful as bound cDNA can be stripped off the disc and re-used.

After PCR, the cDNA PCR products are cloned and sequenced. Unknown sequences can be verified by using them as probes on Southern blots of the digested BAC or PAC DNA.

The present inventors have expressed both PAC and BAC clones and identified, using gene-specific primers, a variety of cDNAs, which include both the expected (published) and predicted (standard annotation programs/hand-annotation) versions and novel splice variants. The BAC or PAC capture methods are being optimized in order to make the procedure widely accessible.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method for preparing genetic material for analysis, comprising:
(a) screening libraries constructed from artificial chromosomes containing genetic regions of interest with a gene-specific probe, wherein a positively-hybridizing artificial chromosome is indicative of the presence of the gene, a portion of the gene, or a closely-related member of a gene family, in the positively-hybridizing artificial chromosome;
(b) transfecting the positively-hybridizing artificial chromosome into a eukaryotic host cell, thereby generating RNA from transcription of the artificial chromosome's genetic material within the host cell; and
(c) isolating the artificial chromosome's RNA from the host cell.

2. The method of claim 1, wherein the artificial chromosomes comprise bacterial artificial chromosomes (BAC).

3. The method of claim 1, wherein the artificial chromosomes comprise P1 artificial chromosomes (PAC).

4. The method of claim 1, wherein the genetic regions of interest comprise human DNA, and wherein the host cell is a non-mammalian cell.

5. The method of claim 1, wherein the genetic regions of interest comprise non-mammalian DNA, and wherein the host cell is a mammalian cell.

6. The method of claim 5, wherein the non-mammalian DNA comprises invertebrate or fish DNA.

7. The method of claim 1, wherein the host cell is the cell of a tumor cell line.

8. The method of claim 1, wherein the host cell is a human embryonic kidney 293 cell or a mouse NIH 3T3 cell.

9. A method for identifying variations in gene transcription, comprising:
(a) screening libraries constructed from artificial chromosomes containing genetic regions of interest with a gene-specific probe, wherein a positively-hybridizing artificial chromosome is indicative of the presence of the gene, a portion of the gene, or a closely-related member of a gene family, in the positively-hybridizing artificial chromosome;
(b) transfecting the positively-hybridizing artificial chromosome into a eukaryotic host cell, thereby generating RNA from transcription of the artificial chromosome's genetic material within the host cell;
(c) isolating the artificial chromosome's RNA from the host cell; and
(d) analyzing the artificial chromosome's RNA for transcriptional variation.

10. The method of claim 9, wherein the artificial chromosomes comprise bacterial artificial chromosomes (BAC).

11. The method of claim 9, wherein the artificial chromosomes comprise P1 artificial chromosomes (PAC).

12. The method of claim 9, wherein the host cell is the cell of a tumor cell line.

13. The method of claim 9, wherein said analyzing of (d) comprises cloning the isolated RNA into a vector.

14. The method of claim 13, further comprising sequencing the cloned RNA.

15. The method of claim 9, wherein said analyzing of (d) comprises amplifying the isolated RNA.

16. The method of claim 15, wherein said amplifying is carried out using polymerase chain reaction.
